(19) United States
(12) Patent Application Publication
(10) Pub. No.: US 2010/0143678 A1
(43) Pub. Date: Jun. 10, 2010

(54) HIGH BARRIER, HEAT-SEALABLE ROLL OR POUCH STOCK

(76) Inventors: Bill Reilly, Newmarket (CA); Chris Mayes, Innisfil (CA)

Correspondence Address: GIFFORD, KRASS, SPRINKLE,ANDERSON & CITKOWSKI, P.C, PO BOX 7021, TROY, MI, 48007-7021, US

(21) Appl. No.: 12/630,258

(22) Filed: Dec. 3, 2009

Related U.S. Application Data
(60) Provisional application No. 61/120,210, filed on Dec. 5, 2008.

(51) Int. Cl. B32B 7/02; B32B 7/12

(52) U.S. Cl. 428/212; 428/347

(57) ABSTRACT

A heat-sealable roll or pouch stock laminated barrier material is disclosed and comprises: a compostable first layer; a compostable, heat-sealable second layer; and a metallized compostable film disposed between the first and second layers. The first layer can be selected from: (i) compostable film; and (ii) a coating layer and a paper layer, the paper layer being disposed between the coating layer and the metallized compostable film. The first layer can be secured to the metallized compostable film with an adherent selected from adhesive and extrudate. The second layer can be selected from a hermetically-sealable film and an extrudate. When present, the hermetically-sealable film is secured to the metallized compostable film with an adherent selected from adhesive and extrudate.

### CROSS-REFERENCE TO RELATED APPLICATION

This application claims benefit of the filing date of and right of priority of U.S. Provisional Patent Application Ser. No. 61/120,210 filed Dec. 5, 2008.

### FIELD OF THE INVENTION

The present invention relates to materials used for packaging.

### BACKGROUND OF THE INVENTION

Many packaging formats require stock which is heat-sealable and has high barrier properties [WVTR: App 0.1 g/100si/d @ 38C/90% RH; O₂TR: App 0.1 cc/100si/d/a @ 23C/0% RH]. Roll stocks used for this purpose [high-barrier, heat-sealable] typically include aluminum foil or metallized films for barrier properties and polyolefin layers for seal properties. These materials cannot be composted, are not sustainable, and have carbon footprints which approximate 5 kg CO₂/kg.

### SUMMARY OF THE INVENTION

Forming one aspect of the invention is a combination of largely compostable materials, which combination can be hermetically sealed from roll stock on either horizontal or vertical form-fill-seal packaging equipment, or can be made into preformed pouches.

According to another aspect of the invention, the material can comprise: a compostable first layer; a compostable, heat-sealable second layer; and a metallized compostable film disposed between the first and second layers.

According to other aspects of the invention:
the first layer can be selected from: (i) compostable film; and (ii) a coating layer and a paper layer, the paper layer being disposed between the coating layer and the metallized compostable film;
the first layer can be secured to the metallized compostable film with an adherent selected from adhesive and extrudate;
the second layer can be selected from a hermetically-sealable film and an extrudate; and
when present, the hermetically-sealable film can be secured to the metallized compostable film with an adherent selected from adhesive and extrudate.

According to other aspects of the invention:
the compostable film of the first layer, when present, can be cellulose;
the coating layer, when present, can be lacquer;
the extrudate, when present between the first layer and the metallized compostable film, can be compostable; and
the extrudate, when present between the second layer and the metallized compostable film, can be compostable.

According to other aspects of the invention:
the compostable film of the first layer when present, can be PLA film;
the metallized compostable film can be PLA film;
the coating layer, when present, can be a nitrocellulose lacquer;
the adhesive, when present between the first layer and the metallized compostable film, can be polyester;
the adhesive, when present between the second layer and the metallized compostable film, can be polyester;
the second layer can be starch-PET;
the extrudate, when present between the first layer and the metallized compostable film, can be starch-PET; and
the extrudate, when present between the second layer and the metallized compostable film, can be starch-PET.

According to another aspect of the invention, the material can further comprise a layer of ink, and:
the first layer can be compostable film and the layer of ink can be commercial ink for film disposed between the first layer and the metallized compostable film; or
the layer of ink can be compostable nitrocellulose ink disposed between the paper layer and the coating layer of the first layer.

According to another aspect of the invention:
the coating layer can be about a 1 gsm coating layer when present;
the paper layer can be about a 40 gsm to about a 50 gsm paper layer when present;
the commercial ink for film can be about a 3 gsm layer when present;
the nitrocellulose ink layer can be about a 2 gsm layer when present;
the polyester adhesive between the first layer and the metallized compostable film can be present at about 1 gsm, when present;
the polyester adhesive between the second layer and the metallized compostable film can be present at about 1 gsm, when present;
the starch-PET extrudate between the first layer and the metallized compostable film can be present at about 10 gsm, when present;
the starch-PET extrudate between the metallized compostable film and the a hermetically-sealable film of the second layer can be present at about 10 gsm, when present;
the PLA film of the first layer, when present, can be about a 90 gsm film;
the metallized compostable film can be about a 90 gsm film; and
the starch-PET extrudate of the second layer can be present at about 38 microns thickness, when present.

Other advantages and features of the invention will become apparent to persons of ordinary skill in the art upon review of the appended claims and the following detailed description, in combination with the attached drawings, the latter being briefly described hereinbelow.

### BRIEF DESCRIPTION OF THE DRAWINGS

FIG. 1 is a cross-sectional view of a first exemplary embodiment of the invention; and

FIG. 2 is a cross-sectional view of a second exemplary embodiment of the invention.

### DETAILED DESCRIPTION

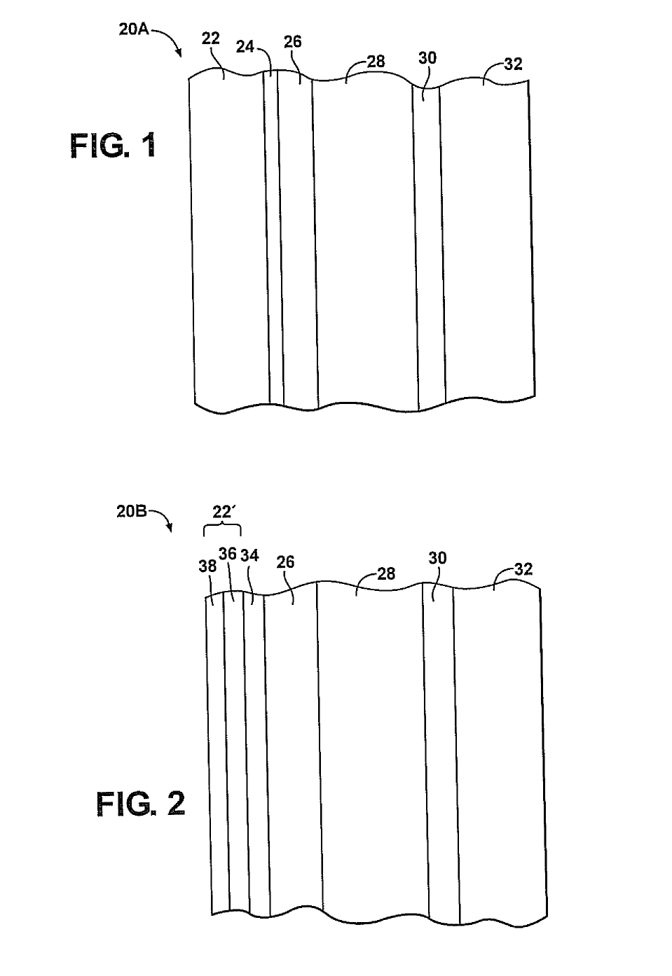

FIG. 1 shows an exemplary embodiment of the invention, specifically, a film 20A.

Broadly described, this film 20A comprises six discrete layers:
22 compostable cellulose Film (first layer)
24 ink
26 adhesive or compostable extrudate
28 metallized compostable cellulose Film
30 adhesive or compostable extrudate
32 compostable hermetically-heat-sealable film or compostable extrudate (second layer)

More narrowly described, this film 20A comprises layers as follows:
22 90 g polyactide (PLA) film, such as the film sold by NatureWorks LLC under the trade-mark NatureWorks
24 3 gsm non-compostible commercial inks for films
26 1 gsm polyester type adhesive [non-compostable and either from 100% or lower solids technology] or 10 gsm starch-PET extrudate, such as the products sold by BASF under the trade-mark Ecoflex and by Novamont under the trade-mark Mater-Bi
28 90 g metallized polyactide film, such as NatureWorks™ film
30 1 gsm polyester adhesive [non-compostable and either from 100% or lower solids technology] or 10 gsm starch-PET extrudate, such as Ecoflex™ or Mater-Bi™
32 38 micron Compostable Hermetically Heat Sealable Starch-PET Extrudate or Film, such as Ecoflex™ or Mater-Bi™
   This film 20A can be hermetically sealed on either horizontal or vertical form-fill-heat-seal packaging equipment, or can be made into preformed pouches. At the same time, this film has advantageous properties in terms of compo stability, sustainability and barrier, specifically:

| | |
|---|---|
| Compostability: | 90% Calculated (ASTM D6400) |
| Sustainability: | 60% |
| Carbon Footprint: | 1.72 Kg CO₂/kg material |
| WVTR: | App 1.5 g/100si/d @ 38 C./90% RH |
| | (Depends on print quality required) |
| O₂TR: | App 0.1 cc/100si/d/a @ 23 C./0% RH |

Packages made from this material may be used at temperatures above 0° C.

In an alternative embodiment of the film 20B, shown in FIG. 2, the cellulose first layer 22 and inside ink layer 24 of the first embodiment can be replaced with a modified first layer 22′ formed of a 40 to 50 gsm paper layer 34, an outer print layer 36 [2 gsm nitrocellulose inks] and a 1 gsm nitrocellulose overlacquer coating 38.

This film 20B can be used at temperatures below freezing, also can be hermetically sealed on either horizontal or vertical form-fill-heat-seal packaging equipment, and can be made into preformed pouches, yet maintains advantageous properties in terms of compostability, sustainability and barrier, specifically:

| | |
|---|---|
| Compostability: | 90% Calculated (ASTM D6400) |
| Sustainability: | 60% |
| Carbon Footprint: | 3.5 kg CO₂/kg material |
| WVTR: | App 2.0 g/100si/d @ 38 C./90% RH |
| O₂TR: | App 0.15 cc/100si/d/a @ 23 C./0% RH |

The manner in which films of the type can be manufactured is a matter of routine to persons of ordinary skill in the art, and as such, a detailed description is neither required, nor provided herein.

Whereas but two specific embodiments of the present invention are herein shown and described, it will be evident that various modifications can be made thereto without departing from the spirit or scope of the invention. Accordingly, the invention is to be construed as limited only by the accompanying claims, purposively construed.

1. A heat-sealable roll or pouch stock laminated barrier material, said material comprising: a compostable first layer; a compostable, heat-sealable second layer; and a metallized compostable film disposed between the first and second layers.

2. A material according to claim 1, wherein
the first layer is selected from: (i) compostable film; and (ii) a coating layer and a paper layer, the paper layer being disposed between the coating layer and the metallized compostable film;
the first layer is secured to the metallized compostable film with an adherent selected from adhesive and extrudate;
the second layer is selected from a hermetically-sealable film and an extrudate; and
when present, the hermetically-sealable film is secured to the metallized compostable film with an adherent selected from adhesive and extrudate.

3. A material according to claim 2, wherein
the compostable film of the first layer, when present, is cellulose;
the coating layer, when present, is lacquer;
the extrudate, when present between the first layer and the metallized compostable film, is compostable;
the extrudate, when present between the second layer and the metallized compostable film, is compostable.

4. A material according to claim 3, wherein
the compostable film of the first layer when present, is PLA film,
the metallized compostable film is PLA film,
the coating layer, when present, is nitrocellulose lacquer,
the adhesive, when present between the first layer and the metallized compostable film, is polyester;
the adhesive, when present between the second layer and the metallized compostable film, is polyester;
the second layer is starch-PET;
the extrudate, when present between the first layer and the metallized compostable film, is starch-PET; and
the extrudate, when present between the second layer and the metallized compostable film, is starch-PET.

5. A material according to claim 4, further comprising a layer of ink, wherein
the first layer is compostable film and the layer of ink is commercial ink for film disposed between the first layer and the metallized compostable film; or
the layer of ink is compostable nitrocellulose ink disposed between the paper layer and the coating layer of the first layer.

6. A material according to claim 5, wherein
the coating layer is about a 1 gsm coating layer when present;
the paper layer is about a 40 gsm to about a 50 gsm paper layer when present;
the commercial ink for film is about a 3 gsm layer when present;
the nitrocellulose ink layer is about a 2 gsm layer when present;
the polyester adhesive between the first layer and the metallized compostable film is present at about 1 gsm, when present;
the polyester adhesive between the second layer and the metallized compostable film is present at about 1 gsm, when present;
the starch-PET extrudate between the first layer and the metallized compostable film is present at about 10 gsm, when present;
the starch-PET extrudate between the metallized compostable film and the a hermetically-sealable film of the second layer is present at about 10 gsm, when present;
the PLA film of the first layer, when present, is about a 90 gsm film;
the metallized compostable film is about a 90 gsm film; and
the starch-PET extrudate of the second layer is present at about 38 microns thickness, when present.
